(19) United States
(12) Patent Application Publication
(10) Pub. No.: US 2015/0251647 A1
(43) Pub. Date: Sep. 10, 2015

(54) SYSTEM AND METHOD FOR CONTROLLING A POWERTRAIN IN A VEHICLE

(71) Applicant: FORD GLOBAL TECHNOLOGIES, LLC, Dearborn, MI (US)

(72) Inventors: Thomas Scott GEE, Canton, MI (US); Douglas Raymond MARTIN, Canton, MI (US); Jesse D.L. BRUNAIS, Livonia, MI (US); Peter Douglas KUECHLER, Canton, MI (US)

(73) Assignee: FORD GLOBAL TECHNOLOGIES, LLC, Dearborn, MI (US)

(21) Appl. No.: 14/198,894

(22) Filed: Mar. 6, 2014

(51) Int. Cl. B60W 10/08; B60W 10/06; B60W 20/00; F02D 29/02

(52) U.S. Cl. CPC B60W 10/08; F02D 29/02; B60W 10/06; B60W 20/10; Y10S 903/902

(57) ABSTRACT

A system and method for controlling a powertrain in a vehicle includes the step of reducing or otherwise modifying a response of the powertrain to accelerator pedal input from a standard powertrain response under certain circumstances, for example, when a position of the accelerator pedal is within a predetermined range and operation of the vehicle meets at least one criteria, including at least one criteria indicative of steady state powertrain operation.

### TECHNICAL FIELD

The present invention relates to a system and method for controlling a powertrain and a vehicle.

### BACKGROUND

Dynamic human behavior can have detrimental effects on fuel economy of a vehicle when it comes to accelerator pedal manipulation. For example, operator induced accelerator pedal oscillations can lead to unwanted fueling response from the control system. Therefore, a need exists for a system and method for controlling a powertrain in the vehicle that reduces or eliminates the unwanted effects of over and under controlling by the vehicle operator.

### SUMMARY

Embodiments of the present invention may include a method for controlling a powertrain in a vehicle that includes reducing a response of the powertrain to accelerator pedal input from a standard powertrain response when a position of the accelerator pedal is within a predetermined range, and operation of the vehicle meets at least one criteria. The at least one criteria may include at least one criteria indicative of steady state powertrain operation.

Embodiments of the present invention may include a method for controlling a powertrain in a vehicle that includes modifying accelerator pedal input to the powertrain from an actual accelerator pedal position input when a position of the accelerator pedal is within a predetermined range, and operation of the vehicle meets at least one criteria. The at least one criteria may include at least one criteria indicative of steady state powertrain operation.

Embodiments of the present invention may include a system for controlling a powertrain in a vehicle that includes a control system including at least one controller configured to reduce a response of the powertrain to accelerator pedal input from a standard powertrain response when a position of the accelerator pedal is within a predetermined range and operation of the vehicle meets at least one criteria. The at least one criteria may include at least one criteria indicative of steady state powertrain operation.

### BRIEF DESCRIPTION OF THE DRAWINGS

FIG. 1 shows a hybrid electric vehicle (HEV) powertrain in accordance with embodiments of the present invention;

FIG. 2 shows a flowchart illustrating a method in accordance with embodiments of the present invention;

FIG. 3 shows a flowchart illustrating a method in accordance with other embodiments of the present invention;

FIG. 4 shows a graph illustrating accelerator pedal position versus time related the flowchart shown in FIG. 2; and

FIG. 5 shows a graph illustrating accelerator pedal position versus time related to the flowchart shown in FIG. 3.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

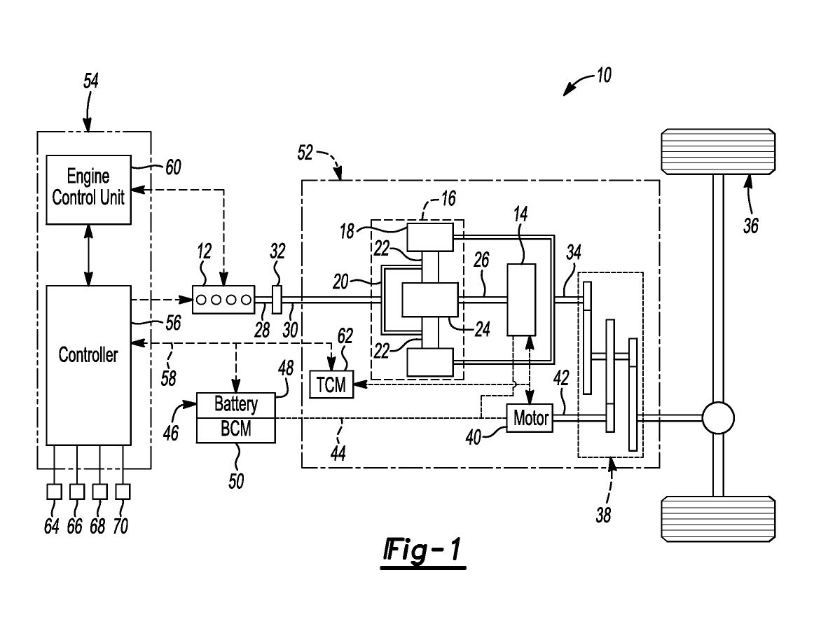

Referring now to the drawings, FIG. 1 is a schematic representation of a vehicle 10, which may include an engine 12 and an electric machine, or generator 14. The engine 12 and the generator 14 may be connected through a power transfer arrangement, which in this embodiment, is a planetary gear arrangement 16. Of course, other types of power transfer arrangements, including other gear sets and transmissions, may be used to connect the engine 12 to the generator 14. The planetary gear arrangement 16 includes a ring gear 18, a carrier 20, planet gears 22, and a sun gear 24.

The generator 14 can also output torque to a shaft 26 connected to the sun gear 24. Similarly, the engine 12 can output torque to a crankshaft 28, which may be connected to a shaft 30 through a passive clutch 32. The clutch 32 may provide protection against over-torque conditions. The shaft 30 may be connected to the carrier 20 of the planetary gear arrangement 16, and the ring gear 18 may be connected to a shaft 34, which may be connected to a first set of vehicle drive wheels, or primary drive wheels 36 through a gear set 38.

The vehicle 10 may include a second electric machine, or motor 40, which can be used to output torque to a shaft 42 connected to the gear set 38. Other vehicles within the scope of the present application may have different electric machine arrangements, such as more or fewer than two electric machines. In the embodiment shown in FIG. 1, the electric machine arrangement—i.e., the motor 40 and the generator 14—can both be used as motors to output torque. Alternatively, each can also be used as a generator, outputting electrical power to a high voltage bus 44 and to an energy storage system 46, which may include a battery pack 48 and a battery control module (BCM) 50.

The battery 48 may be a high voltage battery that is capable of outputting electrical power to operate the motor 40 and the generator 14. The BCM 50 may act as a controller for the battery 48. Other types of energy storage systems can be used with a vehicle, such as the vehicle 10. For example, a device such as a 1 capacitor can be used, which like a high voltage battery is capable of both storing and outputting electrical energy. Alternatively, a device such as a fuel cell may be used in conjunction with a battery and/or capacitor to provide electrical power for the vehicle 10.

As shown in FIG. 1, the motor 40, the generator 14, the planetary gear arrangement 16, and a portion of the second gear set 38 may generally be referred to as a transmission 52. Although depicted as a powersplit device in FIG. 1, other HEV powertrain configurations may be employed, such as parallel or series HEVs. Such powertrains may include engines, transmissions and drive wheels, such as the engine 12, transmission 52 and drive wheels 36 depicted in FIG. 1, or may include different components depending on the configuration. To control the engine 12 and components of the transmission 52—e.g., the generator 14 and motor 40—a vehicle control module 54, such as a powertrain control module (PCM), may be provided. The control module 54 may include a vehicle system controller (VSC), shown generally as controller 56. Although it is shown as a single controller, the controller 56 may include controllers that may be used to control multiple vehicle systems. The control module 54 may include both software embedded within the controller 56 and/or separate hardware to control various vehicle systems.

A controller area network (CAN) 58 may allow the controller 56 to communicate with the transmission 52 and the BCM 50. Just as the battery 48 includes a BCM 50, other devices controlled by the controller 56 may have their own controllers. For example, an engine control unit (ECU) 60 may communicate with the controller 56 and may perform control functions on the engine 12. In addition, the transmission 52 may include a transmission control module (TCM) 62, configured to coordinate control of specific components within the transmission 52, such as the generator 14 and/or the motor 40. Some or all of these various controllers can make up a control system in accordance with the present application. Although illustrated and described in the context of the vehicle 10, which is a HEV, it is understood that embodiments of the present application may be implemented on other types of vehicles, such as a plug-in hybrid electric vehicles (PHEV), those powered by an electric motor alone, or conventional vehicles powered only by an internal combustion engine.

Also shown in FIG. 1 are simplified schematic representations of a braking system 64, an accelerator pedal 66, and a gear shifter 68. The braking system 64 may include such things as a brake pedal, position sensors, pressure sensors, or some combination thereof (not shown) as well as a mechanical connection to the vehicle wheels, such as the wheels 36, to effect friction braking. The braking system 64 may also include a regenerative braking system, wherein braking energy is captured and stored as electrical energy in the battery 48. Similarly, the accelerator pedal 66 may include one or more sensors, which like the sensors in the braking system 64, may communicate information to the controller 56, such as accelerator pedal position. The gear shifter 68 may also communicate with the controller 56. For instance, the gear shifter may include one or more sensors for communicating the gear shifter position to the controller 56. The vehicle 10 may also include a speed sensor 70 for communicating vehicle speed to the controller 56.

The engine 12 may be the sole power source in an HEV, such as vehicle 10. The battery 48 can, however, operate as an energy storage device. For instance, the battery 48 may store power from the engine 12 that has been converted into electricity by the generator 14. Further, the vehicle's kinetic energy may be transformed into electrical energy by the motor 40 during braking and stored in the battery 48. The vehicle 10 may have two sources of motive force or power: the engine 12 and the battery 48. The engine 12 may provide mechanical energy to a driveline via reaction torque provided by the generator 14. The battery 48 may provide electrical energy to the driveline through the motor 40.

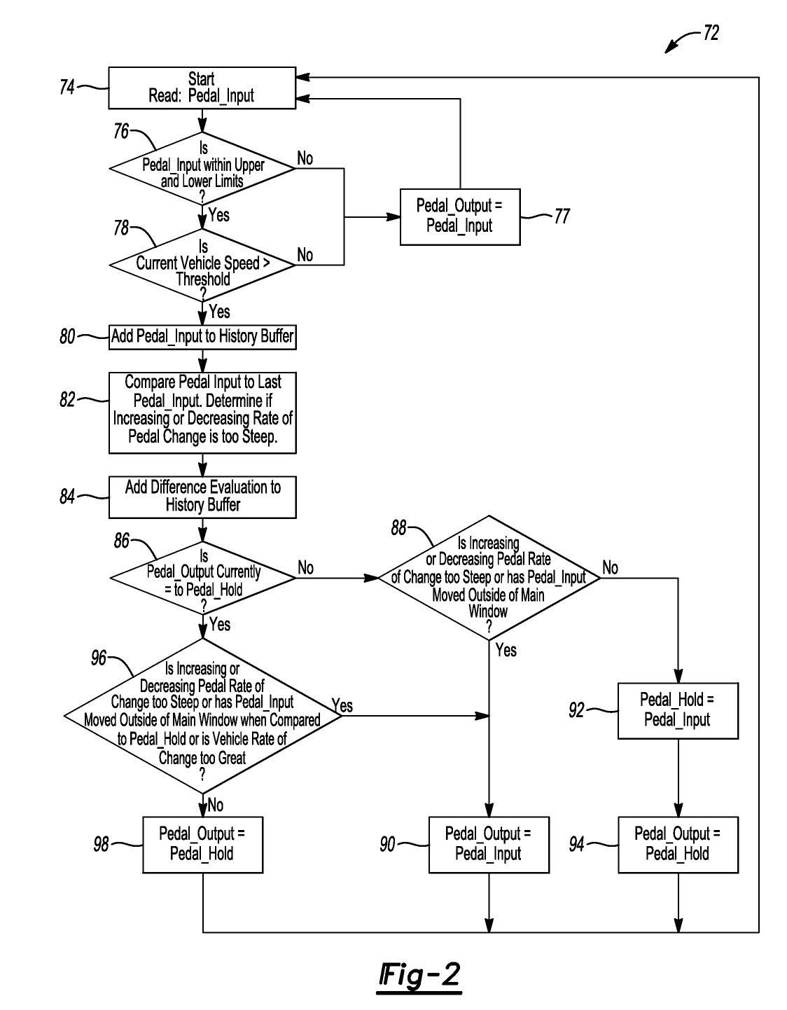

As explained in more detail in conjunction with FIG. 2, one way to reduce or modify a response of a powertrain to accelerator pedal input is to apply a hold function to the powertrain control such that small fluctuations in accelerator pedal position will be ignored. FIG. 2 shows a flowchart 72 illustrating a method in accordance with embodiments of the present invention. At step 74, the method begins and a current position of an accelerator pedal (“Pedal_Input”) is read. At step 76, it is determined whether the current accelerator pedal position—i.e., the current Pedal_Input value—is within certain limits, specifically, whether the accelerator pedal position is within a predetermined range.

The predetermined range may be, for example, an accelerator pedal position that is anywhere between full tip-out and full tip-in, i.e., any accelerator pedal position that is greater than 0% and less than 100%. In other embodiments, the predetermined range may be narrower, which could be accomplished by requiring a greater minimum position, a lower maximum position, or both. Using this criterion helps to ensure that this embodiment of the method is not applied when the accelerator pedal is wide-open or fully closed. If the accelerator pedal position is not within the predetermined range, the method moves on to step 77, and the accelerator pedal position output is set equal to the current pedal position (“Pedal_Output=Pedal_Input”). Thus, if the “hold function”—which is explained in more detail below—is active, it is deactivated; if the hold function is not active, it remains deactivated. The control strategy in the embodiment illustrated in FIG. 2 does not allow the hold function to be active if the current accelerator pedal position is outside the predetermined range. After step 77, the method loops back to the start at step 74.

If the current accelerator pedal position is within the predetermined range as determined at step 76, the method moves on to step 78 where it is determined whether operation of the vehicle meets at least one criteria, which in this embodiment, is whether the vehicle speed is greater than a threshold speed. For example, it may be desirable to limit embodiments of the invention to be applied only when a vehicle is above a certain threshold speed, which may be, for example, 20 miles per hour (mph), though other embodiments may use other minimum speeds as a threshold. If the vehicle is not above this threshold speed, the method moves to step 77, and the hold function is either deactivated or it is kept inactive. After step 77, the method loops back to the start at step 74.

If the vehicle is above the threshold speed, however, the method moves on to step 80, where the current accelerator pedal position is added to the accelerator pedal position history buffer. At 82, the current pedal position is compared with the most recent previous accelerator pedal position (“last Pedal_Input”), and a determination is made whether a rate of change in the accelerator pedal position is too steep. In the embodiment shown in FIG. 2, the rate of change—either increasing or decreasing—is considered too steep if the pedal position changes more than a predetermined threshold of +/−0.5% every 15 milliseconds (msec). Such a change of pedal position may indicate that the accelerator pedal is being tipped-in or tipped-out quickly, and that the vehicle operator intends to accelerate or decelerate quickly, and therefore does not wish to hold the vehicle speed constant. In step 82, the Pedal_Input is compared to most recent previous pedal position, although in other embodiments, comparisons may be made between any number of prior pedal positions over time to determine if the rate of change of the pedal position is too steep.

It is worth noting that because pedal position is often denoted by a percentage—e.g., a percentage of total pedal travel—the +/−0.5% actually indicates a change of 0.5 percentage points from some baseline. Specifically, if the Pedal_Input is increasing or decreasing by more than 0.5 percentage points every 15 msec., then the Pedal_Input is rate of change is considered too steep. As used throughout this description, unless specifically stated otherwise, the percent change values and other criteria using percentages—e.g., the “main window” described below—indicate a change in percentage points from the baseline, not an actual percentage change.

At step 84, the difference between the Pedal_Input and the most recent previous pedal position is added to the pedal position history buffer. At step 86, it is determined whether a “hold function” is currently active—i.e., is the “Pedal_Output” equal to a “Pedal_Hold” value. The “hold function” provides a way to reduce or otherwise modify the response of the powertrain to the accelerator pedal input from a standard powertrain response. This helps to eliminate over and under controlling by a vehicle operator. If the hold function is not active, the method moves to step 88 where a number of criteria are evaluated. One of the criteria is similar to the evaluation made at step 82—i.e., whether the accelerator pedal position rate of change is too steep. One difference, however, is that in step 85, more than two samples are used to make this determination. The chosen number of samples can be analyzed per unit time to determine if the changes are greater than +/−0.5% every 15 msec.

Another determination is made at step 88, specifically, whether the Pedal_Input has moved outside of some predetermined limits—i.e., the “main window” as recited in block 88. In the embodiment shown in FIG. 2, the predetermined limits are defined as a change of pedal position of more than +/−5%. As described above, the +/−5% actually indicates a difference of more than five percentage points. In this step, the Pedal_Input is compared to all of the other pedal positions stored in the history buffer, and if the Pedal_Input is more or less than five percentage points away from any of the stored pedal positions, then the Pedal_Input is considered outside the main window. For example, if the Pedal_Input value is 20%, the Pedal_Input will be considered outside the window if any of the other values in the history buffer are less than 15% or more than 25%. In other embodiments, different limits may be used, depending on how much pedal movement will be allowed before the hold function is not allowed or deactivated.

If a determination is made at step 88 that the rate of pedal change is too steep, or that the Pedal_Input has moved outside the main window—i.e., if the answer to either of these two inquiries is “Yes”—then the method moves to step 90, which is the same as step 77—i.e., “Pedal_Output=Pedal_Input”. Thus, if the hold function is active, it is deactivated; if the hold function is not active, it remains deactivated. Conversely, if the rate of change of the pedal position is not too steep, and if the Pedal_Input has not moved outside the main window, then activating the hold function is indicated, as shown in step 92, where the “Pedal_Hold” value is set equal to the Pedal_Input. This leads to step 94, where the Pedal_Output is set equal to the Pedal_Hold—i.e., the hold function is active.

Returning to step 86, if it is determined that the hold function is active—i.e., if Pedal_Output is equal to Pedal_Hold—then the method moves to step 96 where certain other determinations are made. Similar to step 88, it is determined whether the accelerator pedal position rate of change is too steep. The same criteria as used in step 88 can also be used in step 96—that is, whether the pedal position changes more than +/−0.5% every 15 milliseconds (msec). In addition, the same number of samples may be analyzed as were analyzed in step 88, or a different number of samples may be chosen.

Another determination is also made at step 96, specifically whether the Pedal_Input has moved outside the window when compared to Pedal_Hold. Because it was determined at step 86 that the hold function is active, there will be a Pedal_Hold value that can be compared to the current accelerator pedal position—i.e., the Pedal_Input. Again, the window chosen for the analysis in step 96 may be the same window used in step 88, which was +/−5%; however, in this analysis the 5% indicates a difference of five percentage points above or below the Pedal_Hold value, not the stored Pedal_Input values. For example, if the Pedal_Hold value was set at 20%, the Pedal_Input would be considered outside the main window if it were less than 15% or greater than 25%. In order to determine the trend of accelerator pedal position input, a number of “Pedal_Input” values may be used. Specifically, a “bit mask” may be utilized, indicating that a number of samples would be used for the analysis. For example, the current Pedal_Input as well as several previously read and stored Pedal_Input values could each be compared to the Pedal_Hold value, and if any of them were outside of the window the answer to the inquiry would be “Yes”.

Another determination is made at step 96, specifically whether the vehicle speed rate of change is too great. Similar to the increasing or decreasing pedal rate of change being too steep, a change in vehicle speed rate that is beyond a predetermined value could indicate that the vehicle operator does not wish to maintain a constant speed, and therefore the hold function would not be indicated. In the embodiment shown in FIG. 2, the vehicle speed rate of change may be considered too great if it is more than 3 mph every 15 msec., although other rates of change may be used as a threshold. If the answer to any of the inquiries made in step 96 is “Yes” the method moves to step 90 indicating that the hold function should be deactivated. Conversely, if the answer to each of the inquiries at step 96 is “No” then the method moves to step 98 where the Pedal_Output is set equal to the Pedal_Hold value. From steps 90, 94 and 98, the method loops back to the start at step 74 where the Pedal_Input is read again and a new determination is made as to whether the hold function should be active.

Because the accelerator pedal position is read at step 74 at some predetermined frequency, for example every few milliseconds, the method illustrated in the flowchart 72 is being updated very frequently and the hold function can be activated or deactivated as conditions change. When the hold function is active, one way to control the powertrain with a constant accelerator pedal input, even in light of small accelerator pedal position changes, is to hold fuel input and throttle position constant if an engine, such as the engine 12, is powering the vehicle. If the vehicle is being driven by an electric motor, such as the motor 40 shown in FIG. 1, then controlling the powertrain with a constant accelerator pedal input can include providing torque requests to the traction motor that will maintain a constant, or nearly constant, vehicle speed. If the vehicle is a hybrid vehicle, such as the vehicle 10 shown in FIG. 1, and it is being driven both by engine and electric motor power, then a combination of these control methods can be used.

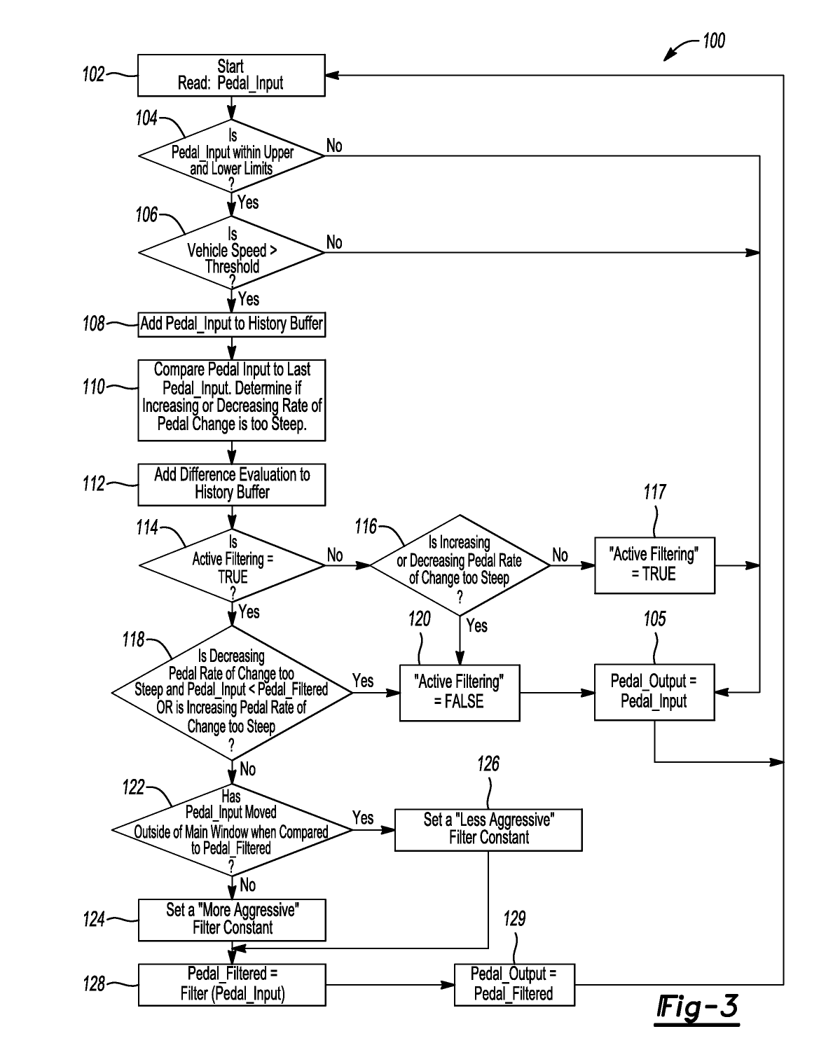

Another way in which a response of the powertrain to accelerator pedal input can be reduced or modified is by filtering the accelerator pedal input, rather than holding it constant. FIG. 3 shows a flowchart 100 illustrating one such method in accordance with embodiments of the present invention. The method starts at step 102 where the current accelerator pedal position (“Pedal_Input”) is read. Next, it is determined at step 104 if the current pedal position is within certain specified limits. Similar to the hold function strategy described in FIG. 2, these limits may be, for example, anything more than 0% and less than 100% of pedal travel, though narrower limits may be used.

If the accelerator pedal position is not within these limits, the method moves on to step 105, and the pedal position output is set equal to the pedal input—i.e., Pedal_Output is set equal to Pedal_Input. Thus, if the “filter function”—which is explained in more detail below—is active, it is deactivated; if the filter function is not active, it remains deactivated. The control strategy in the embodiment illustrated in FIG. 3 does not allow the filter function to be active if the current accelerator pedal position is outside the predetermined range. After step 105, the method loops back to the start at step 102. If, however, the accelerator pedal position is within the specified limits, as determined at step 104, the method moves to step 106 where it is determined whether the vehicle speed is greater than some predetermined threshold speed. Similar to the hold function strategy described in FIG. 2, the minimum threshold vehicle speed may be, for example, 20 mph, though other speeds may be used as a threshold. If the vehicle speed is not above the minimum threshold, the method moves to step 105, and the filter function is either deactivated or it is kept inactive. After step 105, the method loops back to the beginning at step 102.

If the accelerator pedal position is within the specified limits and the vehicle speed is above the threshold speed, the method moves on to step 108, where the current pedal position, which was read in step 102, is added to the accelerator pedal position history buffer. Step 110 is similar to step 82 as shown in FIG. 2. Specifically, the current pedal position is compared with the most recent previous accelerator pedal position (“last Pedal_Input”), and a determination is made whether a rate of change in the accelerator pedal position is too steep. Similar to the method illustrated in FIG. 2, the rate of change may be considered too steep if the pedal position changes more than +/−0.5% every 15 milliseconds (msec). In at least some embodiments, this determination is made using only two samples—i.e., the current Pedal_Input and the most recent previous Pedal_Input. Such a change of pedal position may indicate that the accelerator pedal is being quickly tipped-in or tipped-out, and that the vehicle operator intends to accelerate or decelerate quickly, and therefore does not wish to hold the vehicle speed constant. In step 110, the Pedal_Input is compared to most recent previous pedal position, although in other embodiments, comparisons may be made between any number of prior pedal positions over time to determine if the rate of change of the pedal position is too steep.

At step 112, just as in step 84 in FIG. 2, the difference between the current Pedal_Input and the most recent previous Pedal_Input is added to the pedal position history buffer. At step 114, a determination is made as to the state of the filtering function—i.e., is “Active Filtering=True”; if it is not, the method moves to step 116, where a determination is made as to whether the pedal position rate of change is increasing or decreasing too steeply For this determination, the same criteria may be used as that which was used in step 88 illustrated and described in conjunction with FIG. 2. The rate of change may be considered too steep if the pedal position changes more than +/−0.5% every 15 milliseconds (msec). Unlike step 110, which makes a similar determination, the determination made at step 116 may use a larger number of samples of Pedal_Inputs stored in the pedal position history buffer. If the rate of accelerator pedal position change is not too steep, the method moves to step 117, where Active Filtering is set to “True”, and the method moves to step 105 where the Pedal_Output is set equal to the Pedal_Input. Thus, in the next iteration, the answer at block 114 will be “Yes”, since the Active Filtering was set to “True” at step 117.

If the answer is “Yes” at block 114, the method moves to step 118, where two determinations are made. The first determination consists of two parts: first, whether the accelerator pedal rate of change is decreasing more than predetermined amount—e.g., decreasing more than 0.5% every 15 msec.—and second, whether the current pedal position—i.e., the Pedal_Input—is less than the pedal filtered value. In the situation where no pedal filtering has previously been set, the “Pedal_Filtered” variable is given an initial value, which may be, for example, the Pedal_Input value. If both of these criteria from the first determination are met, the method moves to step 120, where the state of Active Filtering is changed to “False”. The second determination made at block 118, is whether the accelerator pedal rate of change is increasing more than predetermined amount, which also may be 0.5% every 15 msec. If the answer to this determination is “Yes”, the method moves to block 120. If, however, the answer to either of the two determinations in block 118 is “No”, then the method moves to block 122, where it is determined whether the Pedal_Input has moved outside of predetermined limits—e.g., the main window—when compared to the Pedal_Filtered value.

For the determination at block 122, each of the values stored in the accelerator pedal position history buffer—including the current Pedal_Input value—may be compared to the Pedal_Filtered value to see if any of the differences are outside of the main window. As described above, the main window can be set so that pedal movement outside of the window indicates that the vehicle operator does not wish to hold the vehicle speed steady; in some embodiments, the window can be a change of +/−5%. So, for example, if none of the Pedal_Input values stored in the history buffer are more than five percentage points away from the current Pedal_Filtered value, the method moves to step 124, where a Pedal_Filtered value is set. The Pedal_Filtered value may be referred to for convenience as a first filter level, and is shown in the flowchart 100 as a “more aggressive” filter constant. Conversely, if any of the Pedal_Input values stored in the history buffer are more than five percentage points away from the current Pedal_Filtered value, the method moves to step 126, where a “second” filter level is set. The second filter level is a “less aggressive” filter constant, and is less than the first filter level applied at step 124.

In both instances—i.e., where the first level of filtering (step 124) or the second level of filtering (step 126) is applied—the response of the powertrain to the actual accelerator pedal input will be reduced or otherwise modified so that the powertrain will not be as responsive to the operator's accelerator pedal input. In the embodiment illustrated in FIG. 3, the second filter level will be less than the first filter level because it is applied when the accelerator pedal position change is outside the predetermined limits. This may be an indicator that the vehicle operator is expecting a greater level of response from the powertrain, and thus the filtering is less in this situation. When the rate of change of the accelerator pedal position is within the predetermined limits, it may indicate that the vehicle operator is not trying to markedly change the speed of the vehicle, and therefore a more aggressive filter is applied.

Either of the methods of applying a hold function or applying a filtering function as described respectively in FIG. 2 and FIG. 3 can be programmed into a control system of the vehicle, such as the control system described above in conjunction with FIG. 1. Specifically, these control strategies can be stored in and executed by one or more of the various controllers associated with a vehicle such as the vehicle 10, for example, the controllers 54, 56, 60, 62. It is understood that other controllers in addition to or instead of these may be a part of a control system that executes the control strategies described above. Regardless of which of the two filters is applied, the method next moves to step 128, where the Pedal_Filtered value is changed from its initial value to the filtered value set at step 124 or 126. Finally, at step 129, the Pedal_Output is set equal to the Pedal_Filtered value, and the process restarts at step 102.

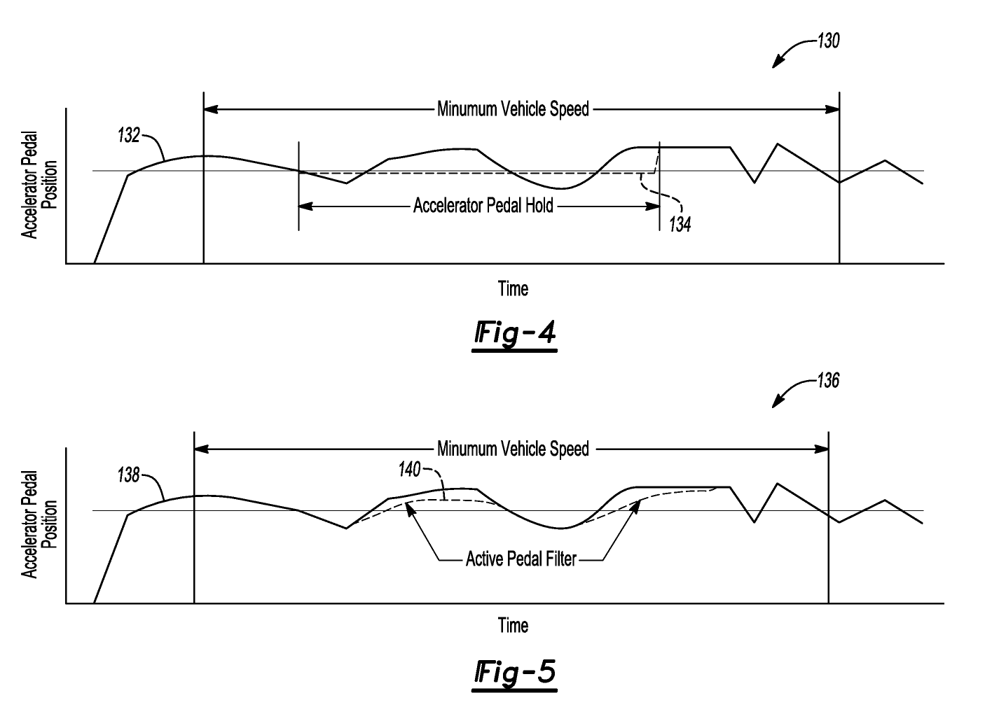

FIGS. 4 and 5 respectively illustrate accelerator pedal position versus time for the hold function and the filter function described above. Specifically, the graph 130 shown in FIG. 4, shows a solid line 132 illustrating the change in actual accelerator pedal position over time. The dashed line 134 illustrated in the middle portion of the graph shows the reduced or modified response of the powertrain when the hold function is applied. Specifically, outside of the range denoted by “Accelerator Pedal Hold” the actual response of the powertrain follows the input of the accelerator pedal as shown by line 132. Within the “Accelerator Pedal Hold” range, however, the actual powertrain response is denoted by the dashed line 134 and the powertrain ignores the slight variations in accelerator pedal position indicated by the solid line 132. It is worth noting that the entire “Accelerator Pedal Hold” range is within a larger range denoted by “Minimum Vehicle Speed”. This coincides with step 78 in FIG. 2, where it is determined whether the vehicle speed is above the minimum threshold prior to activation of the hold function.

Similarly, the graph 136 shown in FIG. 5 shows a solid line 138 illustrating the change in actual accelerator pedal position over time; whereas the dashed line 140 shows the reduced or modified response of the powertrain when the filter function is applied. In contrast to the hold function, which holds the accelerator pedal position generally constant, the filter function allows some variation in accelerator pedal position, but, as illustrated in FIG. 5, the variation of the filtered accelerator pedal position (line 140) is less than the actual variation in accelerator pedal position (line 138). Either of these methods and control strategies—i.e., “holding” accelerator pedal position, or filtering the actual accelerator pedal position input—can be used to reduce unwanted variation in powertrain response to unintended or undesired accelerator pedal position changes, thereby helping to increase vehicle operating efficiency and fuel economy.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for controlling a powertrain in a vehicle, comprising:
reducing a response of the powertrain to accelerator pedal input from a standard powertrain response when a position of the accelerator pedal is within a predetermined range and operation of the vehicle meets at least one criteria, including at least one criteria indicative of steady state powertrain operation.

2. The method of claim 1, wherein reducing the response of the powertrain to accelerator pedal input includes controlling the powertrain with a constant accelerator pedal input during accelerator pedal position changes.

3. The method of claim 2, wherein controlling the powertrain with a constant accelerator pedal input includes holding fuel input and throttle position constant.

4. The method of claim 2, wherein controlling the powertrain with a constant accelerator pedal input includes providing torque requests to a traction motor to maintain a constant vehicle speed.

5. The method of claim 1, wherein reducing the response of the powertrain to accelerator pedal input includes filtering the accelerator pedal input to reduce its effect on the operation of the powertrain.

6. The method of claim 5, wherein filtering the accelerator pedal input includes applying a first filter level when a rate of change of the accelerator pedal position is within predetermined limits.

7. The method of claim 6, wherein filtering the accelerator pedal input includes applying a second filter level less than the first filter level when the rate of change of the accelerator pedal position is outside the predetermined limits.

8. The method of claim 1, wherein the at least one criteria indicative of steady state powertrain operation includes the accelerator pedal not being tipped-in or a tipped-out above a predetermined threshold.

9. The method of claim 1, wherein the at least one criteria further includes a speed of the vehicle being above a threshold vehicle speed.

10. The method of claim 1, further comprising returning the response of the powertrain to accelerator pedal input to the standard powertrain response when at least one of the at least one criteria is no longer met.

11. A method for controlling a powertrain in a vehicle, comprising:
modifying accelerator pedal input to the powertrain from an actual accelerator pedal position input when a position of the accelerator pedal is within a predetermined range and operation of the vehicle meets at least one criteria, including at least one criteria indicative of steady state powertrain operation.

12. The method of claim 11, wherein modifying accelerator pedal input to the powertrain includes providing the powertrain with a constant accelerator pedal input during accelerator pedal position changes.

13. The method of claim 11, wherein modifying accelerator pedal input to the powertrain includes filtering the actual accelerator pedal position input to reduce its effect on the operation of the powertrain.

14. The method of claim 13, wherein filtering the actual accelerator pedal position input includes applying a first filter level when a rate of change of the accelerator pedal position is within predetermined limits.

15. The method of claim 14, wherein filtering the actual accelerator pedal position input includes applying a second filter level less than the first filter level when the rate of change of the accelerator pedal position is outside the predetermined limits.

16. The method of claim 11, wherein the at least one criteria includes the accelerator pedal not being tipped-in or a tipped-out above a predetermined threshold.

17. A system for controlling a powertrain in a vehicle, comprising:
a control system including at least one controller configured to reduce a response of the powertrain to accelerator pedal input from a standard powertrain response when a position of the accelerator pedal is within a predetermined range and operation of the vehicle meets at least one criteria, including at least one criteria indicative of steady state powertrain operation.

18. The system of claim 17, wherein the control system is configured to reduce the response of the powertrain to accelerator pedal input by controlling the powertrain with a constant accelerator pedal input during accelerator pedal position changes.

19. The system of claim 17, wherein the control system is configured to reduce the response of the powertrain to accelerator pedal input by filtering the accelerator pedal input to reduce its effect on the operation of the powertrain.

20. The system of claim 17, wherein the control system is further configured to control the powertrain with the standard powertrain response when at least one of the at least one criteria is no longer met.
